(19) United States
(12) Patent Application Publication
(10) Pub. No.: US 2016/0308839 A1
(43) Pub. Date: Oct. 20, 2016

(54) PIRACY PREVENTION AND USAGE CONTROL SYSTEM USING ACCESS-CONTROLLED ENCRYPTED DATA CONTAINERS

(71) Applicants: Richard Chuang, Sunnyvale, CA (US); David Franklin DeBry, Salt Lake City, UT (US)

(72) Inventors: Richard Chuang, Sunnyvale, CA (US); David Franklin DeBry, Salt Lake City, UT (US)

(21) Appl. No.: 15/001,080

(22) Filed: Jan. 19, 2016

Related U.S. Application Data
(63) Continuation-in-part of application No. 14/306,201, filed on Jun. 16, 2014, now Pat. No. 9,239,933.
(60) Provisional application No. 61/835,045, filed on Jun. 14, 2013.

(51) Int. Cl. H04L 29/06; H04L 29/08

(52) U.S. Cl. CPC H04L 63/0428; H04L 67/104; H04L 63/10; H04L 63/06; H04L 63/20

(57) ABSTRACT

This is a peer-to-peer system for controlling and restricting access (reading, writing, creating, deleting, manipulating, and control) to data and data representations of processing engines through the use of secure containers, an access processing engine, and cryptographic keys.

### CROSS-REFERENCE TO RELATED APPLICATIONS

This application is a continuation-in-part of U.S. patent application Ser. No. 14/306,201 (now U.S. Pat. No. 9,239,933), entitled “Piracy Prevention and Usage Control System Using Access-Controlled Encrypted Data Containers,” filed Jun. 16, 2014 (and issued Jan. 19, 2016), which claims priority under 35 U.S.C. §119 to U.S. Provisional Patent Application No. 61/835,045 entitled, “Piracy Prevention and Usage Control System Using Access-Controlled Encrypted Data Containers,” filed Jun. 14, 2013, the disclosures of all of which are incorporated herein by reference in their entirety as if set forth in full.

### BACKGROUND OF THE INVENTION

1. Field of Invention

The present invention is in the technical field of electronic security. More particularly, the present invention is in the technical field of prevention of data piracy and usage control of software.

2. Description of Related Art

Piracy of software and media is an on-going battle. Piracy costs software developers and content providers millions of dollars a year. In addition, there are many applications where it is desirable to allow resources to be accessed by a user, while preventing the user from copying the resources; for example, when communicating proprietary information.

### SUMMARY OF THE INVENTION

Systems and methods for preventing data piracy and software usage control via access-controlled encrypted data containers are shown and described.

In an embodiment of the invention, a peer-to-peer network communication method implemented between a first user device and a second user device comprises the steps of: storing program instructions and content in a first container at a first user device; mirroring the program instructions and content of the first container to a second secure container at a second user device; and creating, at the first user device, rules governing access to the program instructions and content in the second secure container via an access processing engine residing on the second user device, wherein only the access processing engine residing on the second user device can grant access to the program instructions and content. The step of mirroring the program instructions and content of the first container to the second secure container may comprise the step of encrypting the program instructions and content via one or more cryptographic keys. The method may further comprise the steps of: executing the access processing engine at the second user device; and processing, via the access processing engine, the rules governing access to the program instructions and content, and if the rules permit access, then: decrypting, at the second user device, the program instructions and content in the second secure container via the one or more cryptographic keys; executing, at the second user device, a process according to the decrypted program instructions; and reading, via the process executed at the second user device, the decrypted content; and if the rules do not permit access, then: preventing decryption, at the second user device, of the program instructions and content, execution of a process according to the program instructions, and reading of the content by the process according to the program instructions. The method may further comprise the steps of: updating, at the first user device, the rules governing access to the program instructions and content; and processing, via the access processing engine, the updated rules governing access to the program instructions and content, and if the updated rules permit access, then: decrypting, at the second user device, the program instructions and content in the second secure container via the one or more cryptographic keys; executing, at the second user device, a process according to the decrypted program instructions; and reading, via the process executed at the second user device, the decrypted content; and if the updated rules do not permit access, then: preventing decryption, at the second user device, of the program instructions and content, execution of a process according to the program instructions, and reading of the content by the process according to the program instructions. The method may further comprise the step of storing the rules in the first container. The method may further comprise the step of transferring the rules from the first user device to a remote service. The one or more cryptographic keys are never stored at the second user device. The one or more cryptographic keys are received from a key management engine, wherein the key management engine is remote from the user device. The process is a viewer and the content comprises a document or source code. Alternatively, the process is a media player and the content comprises protected media.

In another embodiment of the invention, a user device comprises: a secure container comprising program instructions and content; an access processing engine, wherein only the access processing engine can grant access to the program instructions and content within the secure container; and rules governing access to the program instructions and content in the secure container via the access processing engine, wherein the rules are created by another user device. The secure container is encrypted via one or more cryptographic keys. The access processing engine is configured to: process the rules governing access to the program instructions and content, and if the rules permit access, then the user device can: decrypt the program instructions and content in the secure container via the one or more cryptographic keys; execute a process according to the decrypted program instructions; and read, via the process, the decrypted content; and if the rules do not permit access, then the user device is prevented from decrypting the program instructions and content, executing a process according to the program instructions, and reading of the content by the process according to the program instructions. The user device may further comprise updated rules governing access to the program instructions, which replace the rules governing access to the program instructions, and wherein the access processing engine is configured to: process the updated rules governing access to the program instructions and content, and if the updated rules permit access, then the user device can: decrypt the program instructions and content in the secure container via the one or more cryptographic keys; execute a process according to the decrypted program instructions; and read, via the process, the decrypted content; and if the updated rules do not permit access, then the user device is prevented from decrypting the program instructions and content, executing a process according to the program instructions, and reading of the content by the process according to the program instructions. The rules are stored in the secure container. The one or more cryptographic keys are never stored at the user device. The one or more cryptographic keys are received from a key management engine, wherein the key management engine is remote from the user device. The process is a viewer and the content comprises a document or source code.

In yet another embodiment of the invention, a secure communication method implemented on a user device comprises the steps of: receiving, at a first user device, program instructions and content from a second user device; storing, at the first user device, the program instructions and content in a secure container, wherein storing the program instructions and content in the secure container comprises the step of encrypting the program instructions and content via one or more cryptographic keys; and receiving, at the first user device, rules governing access to the program instructions and content in the secure container via an access processing engine residing on the first user device, wherein only the access processing engine can grant access to the program instructions and content. The method may further comprise the steps of: executing the access processing engine at the first user device; and processing, via the access processing engine, the rules governing access to the program instructions and content, and if the rules permit access, then: decrypting, at the first user device, the program instructions and content in the secure container via the one or more cryptographic keys; executing, at the first user device, a process according to the decrypted program instructions; and reading, via the process executed at the first user device, the decrypted content; and if the rules do not permit access, then: preventing decryption, at the first user device, of the program instructions and content, execution of a process according to the program instructions, and reading of the content by the process according to the program instructions.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts a piracy prevention and usage control system.

FIG. 2 depicts an exemplary implemented configuration of a piracy prevention and usage control system.

FIG. 3 depicts an exemplary implemented configuration of a piracy prevention and usage control system with the addition of a distribution service.

FIG. 4 depicts a piracy prevention, usage control and distribution system.

FIG. 5 depicts another embodiment of a piracy prevention, usage control, and distribution system.

FIG. 6 depicts yet another embodiment of a piracy prevention, usage control, and distribution system.

FIG. 7 depicts yet another embodiment of a piracy prevention, usage control, and distribution system.

FIG. 8 depicts an embodiment of a user device equipped with piracy prevention, usage control and a distribution system.

### DETAILED DESCRIPTION OF EMBODIMENTS

A detailed description of embodiments of the present invention is presented below. While the disclosure will be described in connection with the drawings, there is no intent to limit it to the embodiment or embodiments disclosed herein. On the contrary, the intent is to cover all alternatives, modifications and equivalents included within the spirit and scope of the disclosure as defined by the appended claims.

In this disclosure, the term “organized data” is used to describe any form of data that has meaningful structure to the end user or the system. Examples of organized data include program instructions; media content such as, but not limited to displayable media (movies, images, pictures, etc.) or music; documents such as, but not limited to text files, Acrobat files, source code files; or more generically data files of any sort. Program instructions are sometimes known in the art as a “binary executable,” “binary code,” or simply as an “executable” or even simply as an “app” or “application.” The program instructions are operable to cause a machine, such as hardware or even a virtual machine, to perform an arbitrary process, i.e., “arbitrary processing engine.” In this disclosure, the term “program instructions” is intended to represent a specific type of organized data that can be instantiated to cause a machine to perform arbitrary processes. When not stated otherwise, “organized data” is intended to encompass any form of organized data.

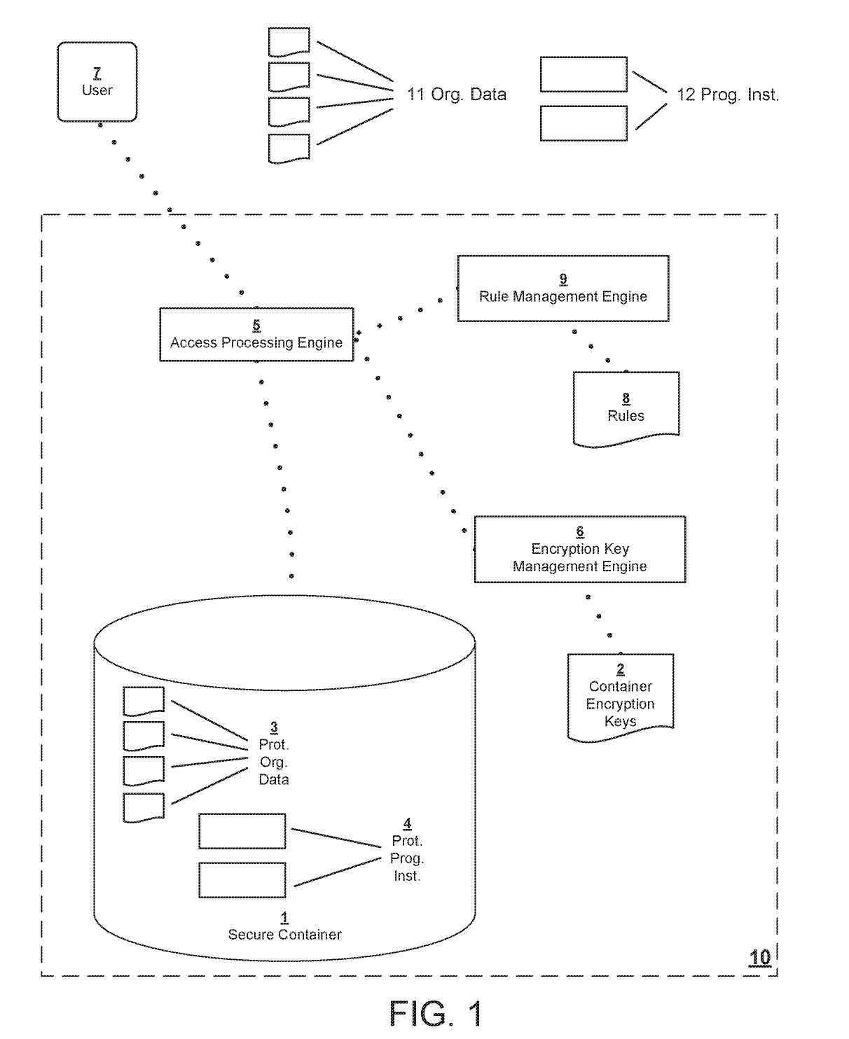

FIG. 1 depicts a piracy prevention and usage control system (10) according to an embodiment of the invention. This system (10) comprises a secure container (1) of organized data (3 and/or 4). The secure container is encrypted such that the data within is only accessible with one or more proper container cryptographic keys (2), the identification and implementation of which are apparent to one of ordinary skill in the art. Though described as a single container in FIG. 1, it should be understood that the secure container (1) can be several secured or encrypted storage containers with one or more cryptographic keys. For the purposes of discussion, multiple containers are referred to collectively as a “secure container” (1).

In an embodiment of the invention, a “secure container” is a file system. For example, the secure container (1) can be an actual physical file system such as, but not limited to an external drive, solid state device, and USB device, or can be a virtual file system, such as an ISO mounted volume, Apple's DMG volume. The secure container (1) can also be an archive file such as a “zip” file. In order to be a secure container, the contents are encrypted and read access requires an access key, i.e., cryptographic key. A “container” is a more generic file system as it may be unsecure or secure as one would have in a secure container.

The individual elements of data (3, 4) are organized in the secure container in such a way that, given the proper container cryptographic keys, the individual elements of data can be referenced and accessed individually or in groups. The data within the container and the organization of that data may change over the lifetime of the secure container. For the sake of example, two exemplary forms of organized data are shown. Depicted is protected content (3) which can be any type of data that is to be protected from copying and program instructions (4) which is data operable to implement a process to perform a desired function, such as that described in the preceding paragraph. However, the system (10) may comprise one or the other, or both.

The system further comprises an access processing engine (5), a cryptographic key management engine (6), and a rules management engine (9). The system (10) can optionally also access unprotected organized data (11). Additionally, it can optionally allow access by processes instantiated from unprotected program instructions (12). Examples of the potential interrelationship between unprotected organized data (11), unprotected program instructions (12), and the system (10) are given below.

The access processing engine (5) manages and controls access to the contents of secure container (1). It should be noted that access to the contents of the secure container (1) is completely controlled by access processing engine (5) and that access processing engine (5) can optionally allow (i.e., grant permission to) external processes, e.g., software, a program, an application, or operating systems, to access the secure container (1) while denying access to other processes. In other embodiments (discussed below), the access processing engine (5) executes and grants the program instructions (4) within the secure container (1) access to the protective organized data (3) and denies access to any other external process. When the processes are embodied in software, the access processing engine (5) can restrict access to the secure container (1) by setting rules based on process identification numbers (IDs) or process handles, the implementation of which is apparent to one of ordinary skill in the art. The rules can also be based on process names, process location, or location of the program instructions which instantiated the process. Furthermore, in many operating systems, processes can spawn child processes. In those operating systems, the access processing engine (5) can place allowance based on the process identifiers or process handles of a process and its ancestors. For example, access processing engine (5) grants permission to a process or any child process of that process access to the secure container (1). In addition, access can also be granted to groups of processes identified by process groups.

In the system described throughout, the secure container can only be accessed through the control of the access processing engine (5). Either the access processing engine directly accesses the content in the secured container and relays and/or limits the content for use by the end user or the access processing engine can direct which processes have access to the content in the secure container. In the former case, the content may be program instructions and the access provided by the access processing engine may be to launch the program. In the latter case, the content may be media content and the access processing engine allows a media player process to view the content. Ostensibly, it may be both where the media player process is started from program instructions also stored in the secure container. The end user cannot directly access or read the content without the access processing engine.

The access processing engine (5) is not limited to either fully declining access or fully rejecting access to the contents of the secure container. The access processing engine may grant or deny access to various aspects of the contents of the secure container individually: separate elements of data, the list of contents of the container, the organization of the container, process control of the program instructions within the container, and so forth.

The access processing engine (5) uses container cryptographic keys (2) for gaining access to the data container. The access processing engine (5) is also aware of the organization of data within the container, such that the engine can access individual elements of data (3,4) within the container, or groups of individual elements. Access control and storage of the cryptographic keys (2) is managed by the cryptographic key management engine (6). In one embodiment, the cryptographic keys (2) are stored in the cryptographic key management engine (6) (as depicted in FIG. 1). In another embodiment, the cryptographic keys (2) are stored external to the system (10) and the cryptographic key management system (6) is responsible for the retrieval of the cryptographic keys (2) as they are needed by the system (10). The access processing engine (5) can retrieve the cryptographic keys as needed and as authorized by the key management engine. It should be noted that the users (7) do not have direct access to the container cryptographic keys (2). As a result, the users must use the access processing engine (5) to access anything held within a secure container.

The rules management engine (9) directs the access processing engine (5) as to the circumstances to which access is to be provided. The rules management engine (9) makes access decisions based on a set of rules (8). As an example, these rules can be a simple access control list where authorized and authenticated users can be granted to protected organized data (3, 4). In another example, licensing rules can be used, where usage is metered, and access is granted based on whether a user has exceeded the allocated licensed usage. Furthermore, rules can dictate the type of access that is permitted, e.g., read, write, delete, execute, etc.

Program instructions are shown as either protected (4) or unprotected (12). These program instructions—if protected—reside within a secure container (1) where the access to the execution of the program instructions is also controlled by the access processing engine (5). Alternatively, the program instructions may not be protected, in which case they reside outside the secure container (1) and the execution of the program instructions need not be controlled by the system (1). The process instantiated by the execution of the program instructions (i.e., the process launched from the instructions) can create, delete read, write, manipulate, and/or control other data held inside (e.g., protected content (3)) or outside a secure container (e.g., organized data (11)).

The access processing engine (5) makes its decisions concerning which users have access to which aspects of the secure container via a set of rules (8). These rules may be held by the access processing engine, or they may be given to the access processing engine from a rule management engine (9). In either case, the rules governing access to a secure container may change over the lifetime of the secure container.

The program instructions (4, 12) may be instantiated multiple times and be launched as multiple processes. These multiple processes may be run simultaneously. The rules (8) may take advantage of this environment, and grant one instantiation of the program instructions access to data within the secure container while another instantiation of the program instructions is denied access.

In one embodiment, a user (7) may not be granted direct access to the data within a secure container, or to read the program instructions (4) within a secure container (1), but the user may be granted control of the program instructions (4) within a secure container (1), i.e., be able to execute the program instructions (4). Further note that the process instantiated from the protected program instructions (4) may itself have been granted access to other data (3, 4) within a secure container. This results in the user gaining limited access to the data within a container, in that the user may only access the data within the limitations of the protected program instructions. This restriction effectively allows for access to be limited based on the reason the user has for accessing the data within the secure container.

The users (7) may be people, or other programs, systems or processes that may reside outside of the secure container, (1) or a process launched from protected program instructions (4) residing within a secure container (1). The access processing engine may grant or decline access to users of the engine when the access processing engine is asked to retrieve data from the container.

System (10) can be configured into many applications dependent on the configuration and functionality of the specific access processing engine (5). In one application, system (10) is employed to protect software from piracy. The software comprises program instructions saved in a file, which is transferred, downloaded or otherwise transmitted into secure container (1). The instructions are protected content (3). The instructions residing in secure container (1) are not accessible by the user and in particular are not readable by the user. Upon request by the user and if permitted by rules (8) as provided by rules management engine (9), the access processing engine (5) instantiates a process from the instructions saved in secure container (1). In other words, the access processing engine launches or runs the program stored in secure container (1). Here, the process is a program, system, engine, application or software routine (collectively, referred to as a “program”), which either is the program granted access to protected content in the secured content, a program created or launched from protected content, or both. For example, the process is a program that is instantiated (i.e., launched) from program instructions that are among the protected content. In this context, the program is being protected from copying. This program may also have access to unprotected content (11) residing outside of the secure container (1). In other applications, the program may also have access to other protected content (3,4) residing inside secure container (1). The access processing engine controls the user's ability to launch the program while the secure container prevents the user from reading the program instructions that enabled the program so that they cannot copy the program.

The transfer of the protected content, be it program instructions, media content, or documents is implemented using a form of encryption. As an example, a secure socket layer (SSL) can be used to protect the transmission of the protected content so that it is not intercepted before being received into the secured container. SSL is applicable to the system regardless of whether a client-server configuration or a peer-to-peer configuration is used.

Furthermore, as described in more detail below, the rules management engine (9) may dictate when, how long and how many instances of the program the user may launch. For example, there could be a limitation on total hours a given user is permitted to run a program. Furthermore, the user could be restricted to running the program at certain times.

Taking this example further, because the access processing engine (5) can grant access to the program to access additional protected content inside the secure container (1), the program can be used as a method for the user to use the additional protected content without granting the user the ability to digitally read the protected content. More specifics on the various ways to implement licenses are described in greater detail below.

As a specific example, when the system (10) is employed to protect a movie, access processing engine (5) could allow a movie player process, possibly identified by a process ID to access a protected movie as an example of protected content (3). This movie player process might have special features, such as a watermarking feature which embeds a visible or invisible watermark into the movie being view so if the movie were copied by hacking or screen grabbing. The watermark will indicate the origin of the unauthorized copy. The access processing engine (5) would deny access to the movie for any other player. In effect, the protected movie can only be played by the specially designated movie player. In one variation, the movie player can be represented as protected program instructions (an example of program instructions (3)) or as an example of unprotected program instructions (12)).

In a protective mode, the protected content (3) comprises both program instructions for a movie player and a digital representation of the movie. When permitted by the access processing engine (3), the movie player is instantiated and launched from the program instructions and given permission to read the digital representation of the movie. The movie player should be limited to the ability to playback a movie and not have any features that would enable the user to save the movie. The movie representation can be in a standard format such as, but not limited to MP4 or a proprietary format. Additional security from piracy would include a proprietary format so that only the movie player stored in the secure container could playback the movie. To further bolster security, the movies could be encrypted with the decryption key built into the movie player.

Access to the movie can also governed by rules (8), which could limit the number of times a movie could be viewed, or the duration it can be viewed. It can also set an expiration date for when a movie can be viewed. Additionally, a rule could dictate what time of day a movie can be viewed.

It should be noted that at no time in this process does the end user have the ability to read or copy either the movie player or the movie as both are stored inside secure container (1).

In another specific example, system (10) could be employed to protect sensitive documents and access processing engine (5) could allow specialized document viewers to access protected documents such as, but not limited proprietary source code or technical information. This specialized viewer could restrict the ability to print, edit and copy the documents, but could permit viewing and searching. The access processing engine (5) would deny access to any other process such as a generic text editor. This would prevent unauthorized copying and printing of the protected documents. As before the specialized document viewer(s) could be represented by program instructions either as protected or unprotected.

In the same way, protected content can include program instructions for a movie player and digital representations of a movie. The protected content could comprise a music player and digital representation of music or could comprise a media player and some other form of media, or as in the example above, could include document viewers and documents. By protecting both the “player” and the “playable content” from copying by the end user, access to the “playable content” can be controlled and the copying of the playable content can be prevented, thereby posing an obstacle to content piracy.

In another specific example, system (10) could be employed to protect an application, access processing engine (5) based on licensing criteria could allow a specific set of program instructions (an example of program instructions (4)) to be instantiated into a process (i.e., “launched”). For example, the program instructions could be the “executable” for an image rendering program. The rendering program may need to access protected assets (an example of protected content (3)) that may be provided by a film studio and access to unprotected assets (an example of organized data (11)) provided by the artist end user. Access processing engine (5) in this example would only allow the rendering program to be launched if license conditions were met and can only allow the rendering program to access the protected assets and no other programs. Furthermore, the access could be metered and access could be denied and/or current sessions of the rendering program could be terminated when a given usage limit has been reached or when a license is revoked. Countless other license policies could be imposed. Access could be denied when usage limit has been reached, but current sessions could be permitted to continue to execute based on an allowed overuse policy and only when that policy has been exhausted is the program terminated.

System (10) could be encapsulated in a single device or components may be spread across several devices and servers coupled by a computer network. For example, access processing engine (5) along with secure container (1) could reside on an end user device such as a computer, tablet, or smartphone. The rule management engine (9) and cryptographic key management engine (6) could reside on a single server or separate servers. Furthermore, the rules (8) which can be implemented in a database or as a set of instructions, may reside on the same or different server from rule management engine (9). Likewise, computer cryptographic keys (2) which can reside in a database can reside on the same or different servers from cryptographic key management engine (6). In an embodiment of the invention, each node, i.e., user device, implements one or more unique cryptographic keys. For example, each node has its own and a different set of one or more cryptographic keys.

It should be noted that in the subsequent configuration, unprotected organized data (11) and unprotected program instructions (12) are not depicted.

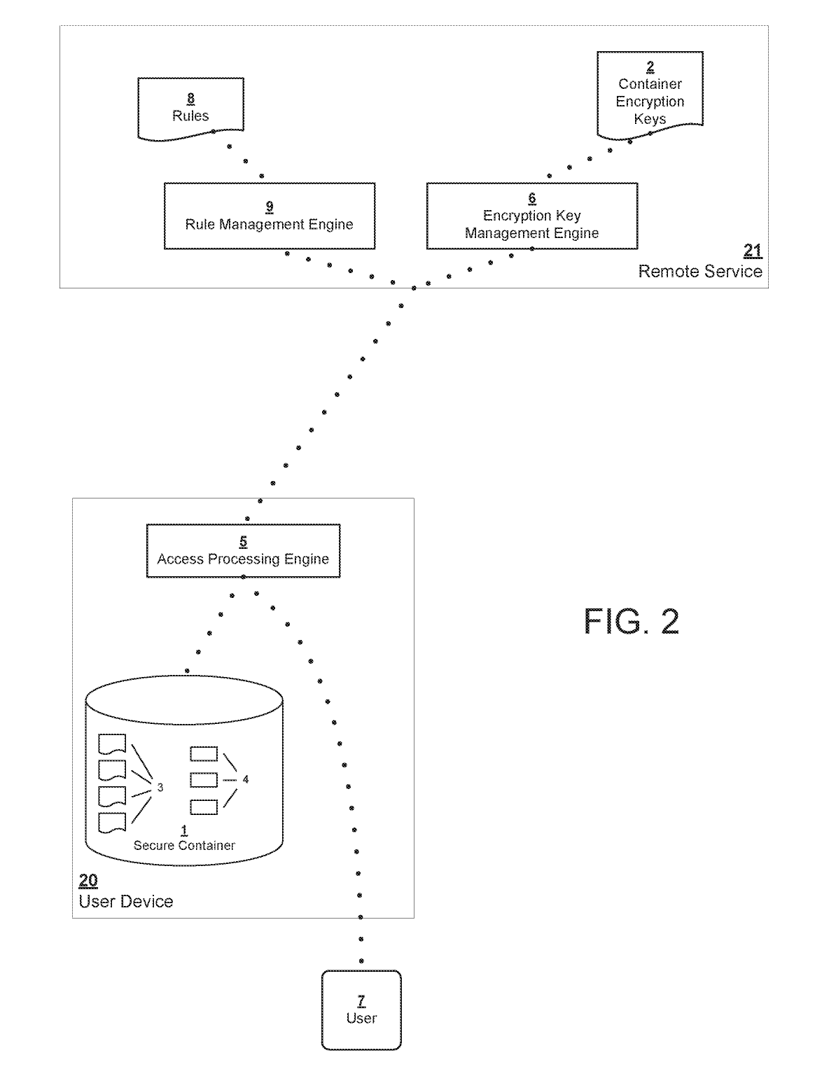

System (10) could be encapsulated in a single device or components may be spread across several devices and servers coupled by a computer network. FIG. 2 depicts an exemplary implemented configuration of system 10, where a user device (20) comprises access processing engine (5) along with secure container (1). Specific examples of user device (20) include, but are not limited to a computer, tablet or smartphone. In addition, a remote service (21) comprises rules management engine (9) along with rules (8) and cryptographic key management engine (6) along with cryptographic keys (2). The implementation of the components of the remote service (21) can be a server or collection of servers. In the latter case, separate servers may comprise the rules management engine (9) and cryptographic key management engine (6). The rules (8) can be implemented in one or more databases or as a set of instructions and may reside on a server of its own or combined with the servers used for the rules management engine (9). The cryptographic keys (2) can be stored in a database and can reside on the same or different servers from cryptographic key management engine (6).

In the configuration of FIG. 2, access to the protected data (3, 4) is controlled by a remote service (21). This configuration can be used, for example, where a movie segment is offered for viewing for limited time to some individuals. The remote service is controlled by the content owner. If the content owner wishes to revoke access even before the limited time to certain individuals, they can. This enables the owner to change the terms of the license at any time.

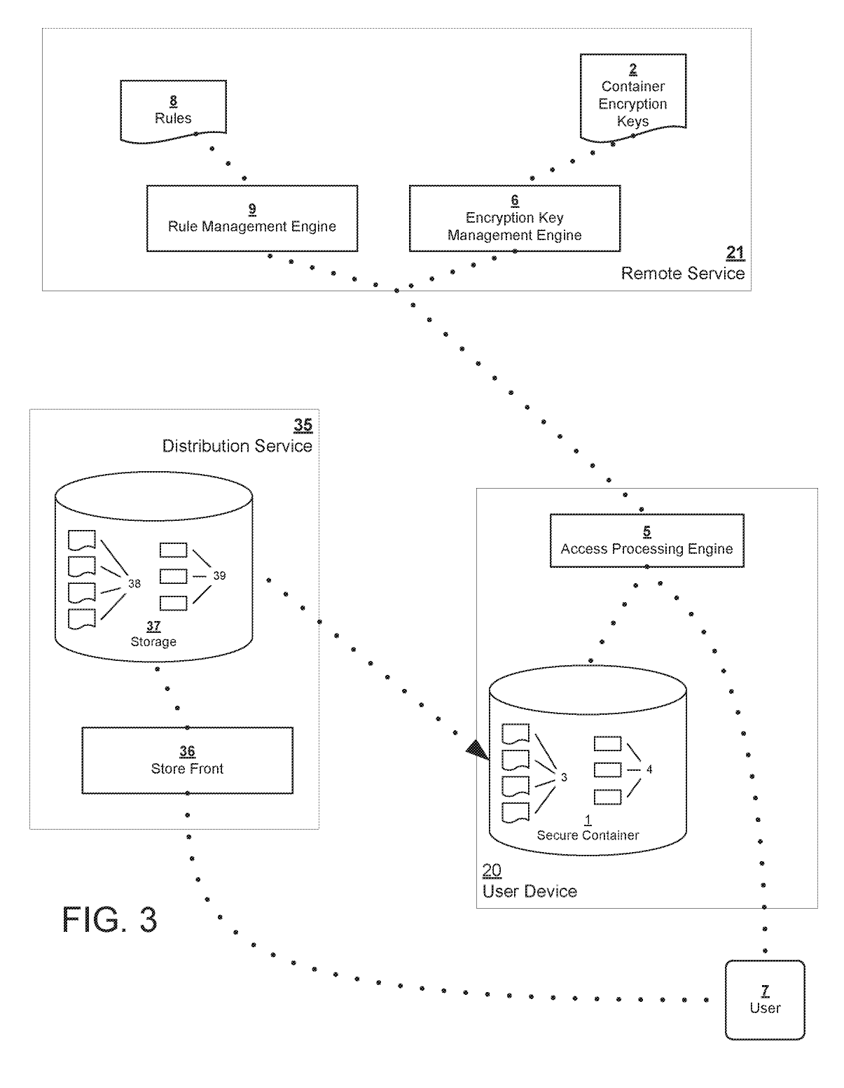

FIG. 3 depicts the system as shown in FIG. 2 with the addition of a distribution service. In addition to the components described in the user device (20) and the remote service (21), a distribution service (35) is included. Distribution service (35) comprises storage (37) where many protected collections of organized data (38, 39) are housed. Based on access rights, user device can download protected program data (i.e., an app) or other protected organized data (e.g., a movie, e-book, song, etc.) into the secure container (1). The data can be transmitted over a network using any type of protocol including, but not limited to Bittorrent, file transfer protocol (FTP) or secure FTP (SFTP), or one of the countless other protocols known now or later to one of ordinary skill in the art. The data as transmitted should be encrypted so that only the access processing engine is able to decrypt the data as it stores the data into the secure container (1). This prevents the protected data from being intercepted on the network or by the user (7). The distribution service (35) can further comprise a store front. The storefront can be an interface which allows the user (7) to purchase, lease, or otherwise license some unit of protected data (38, 39) in storage 37.

For example, a movie rental company could provide a warehouse of movies (such as protected data (38)). The user (7) can use a browser to access the storefront (36) which in this example is embodied as a business web site. Upon selecting and purchasing a movie, the movie is downloaded directly into the secure container (1) by the access processing engine (5). Alternatively, the user could elect to rent a movie. The movie is downloaded just as in the case of a purchase, but the rules allow the user to only view the movie within the rental period. Thereafter, the access processing engine (5) would disallow access. In both cases, the access processing engine (5) may offer the user the option to delete the movie from the secure container (1) in order to save disk space.

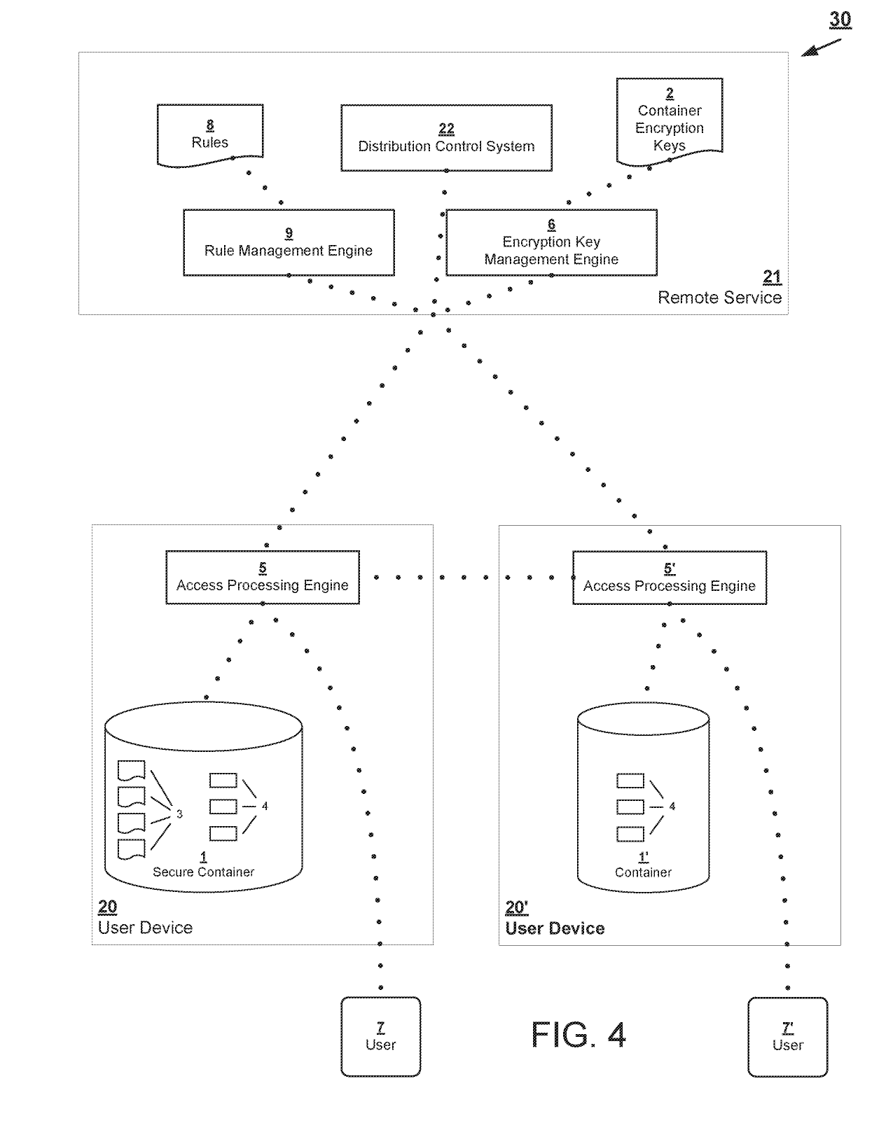

FIG. 4 depicts a piracy prevention, usage control and distribution system. In addition, a second user (7′) known as the content owner can deposit into a container (1′) on user device (20′) protected program instructions (4). These program instructions could be run on a user device. It may also include content. For example, the program instructions could implement a movie playing app and a movie which is to be protected. In addition, the remote service (21) could also comprise a distribution control system (22). Distribution control system (22) determines whether the user (7) is permitted to receive data from the content owner (7′). If user (7) is permitted to receive the content from the content owner (7′), the protected program instructions are transferred from container (1′) to secure container (1). The data can be transferred using a peer-to-peer protocol such as, but not limited to Bittorrent, a client server protocol such as FTP or SFTP, or one of the countless other protocols known now or later to, and the implementation of which are apparent to, one of ordinary skill in the art.

By allowing direct connection between user devices, especially using peer to peer protocol, the protected program instructions can be distributed efficiently. Furthermore, if the contents of container (1′) and secure container (1) are continually mirrored, a content owner (7′) could distribute new content or upgrades to user (7) by putting new data into container (1′). Additionally, access processing engine (5) can also write data into container (1) which is mirrored back to container (1′). This data can be used to track usage of protected data (3, 4).

Furthermore, individual license information could be transmitted from content owner (7′) into secure container (1) which can be read by access process engine (5) to limit the use of protected data (3, 4) based on the license information, such a limiting the usage of the protected data (3, 4) to a given amount of time, or limiting the number of concurrent instances of protected data (3, 4) to a preset limit. (An instance of non-program instructions could represent any kind of usage, for example, for a video file, an instance would be one application playing the movie, so the system could limit a movie for example, to only two concurrent showings.)

More specifically, access processing engine (5) can track usage by a user or can be configured with a group of users such as users on a specific project which can share in the allotted usage. Furthermore, access processing engine (5) can keep track of or limit the number of simultaneous instances of protected data (3, 4) and can count usage accordingly. For example, the content owner may allow simultaneous usage and only charge by absolute wall clock time or may charge for each instance so if a user or project runs two instances the usage number will increase at double the rate.

Furthermore, the access processing engine (5) can be equipped with process control, so that the protected data (3, 4) can be instantiated, terminated, and regulated without any modification to the protected data. In other words, when the protected data are protected program instructions (4), the protected program instructions do not have to be modified to take advantage of the usage licensing features.

In a complex system with many secure containers per device, the access processing engine along with a distribution control system (22) can be used for distributing software and data for a collaborative workflow system without exposing the contents of the proprietary workflow. The proprietary workflow could comprise software, particularly software under license, and data such as work product or content. For example, in a production pipeline, a workflow could comprise supplying assets to a rendering program to produced rendered output. It may be desirable to limit access to the assets, rendering program and to the rendered output.

In yet another embodiment of the invention, container (1′) could be a secure container only accessible by the access processing engine (5′), so that user (7′) could only add organized data to the container (1′) by using the access processing engine (5′). This can be used to ensure that the organized data is in a form usable to other user devices (e.g., user device 20) and to prevent user (7′) from intentionally or inadvertently introducing a security threat. As an additional security measure, access processing engine (5′) can scan the organized data for viruses.

It should be noted that in this distribution system the remote service (21) has no control over the actual licensing of the protected program instructions (4) nor does the remote service (21) have access to protected program instructions, since this control is between user device (20) and user device (20′).

Another application of the system is in the control of confidential documents. As an example, in the field of law, adverse parties are often obligated to share documents containing highly sensitive information. Source code has been especially troublesome. For software companies, their source code is the entire value of their company. Protective orders often place burdensome restrictions on access to source code making it difficult for the adversarial party's representatives to properly review the code and often requiring them to travel to remote sites.

However, if the source code was placed into a content owner's container along with special reviewing applications that allowed search, tagging, Bates number and reviewing, the adversarial party's representatives can conveniently review the source code. Meanwhile, times of access and list of accessing users can be tracked and provided to the content owner. Furthermore, the content owner has the ability to remove users from the access list. After the case is resolved, the cryptographic keys can be deleted and the secure container on the reviewing system is rendered useless.

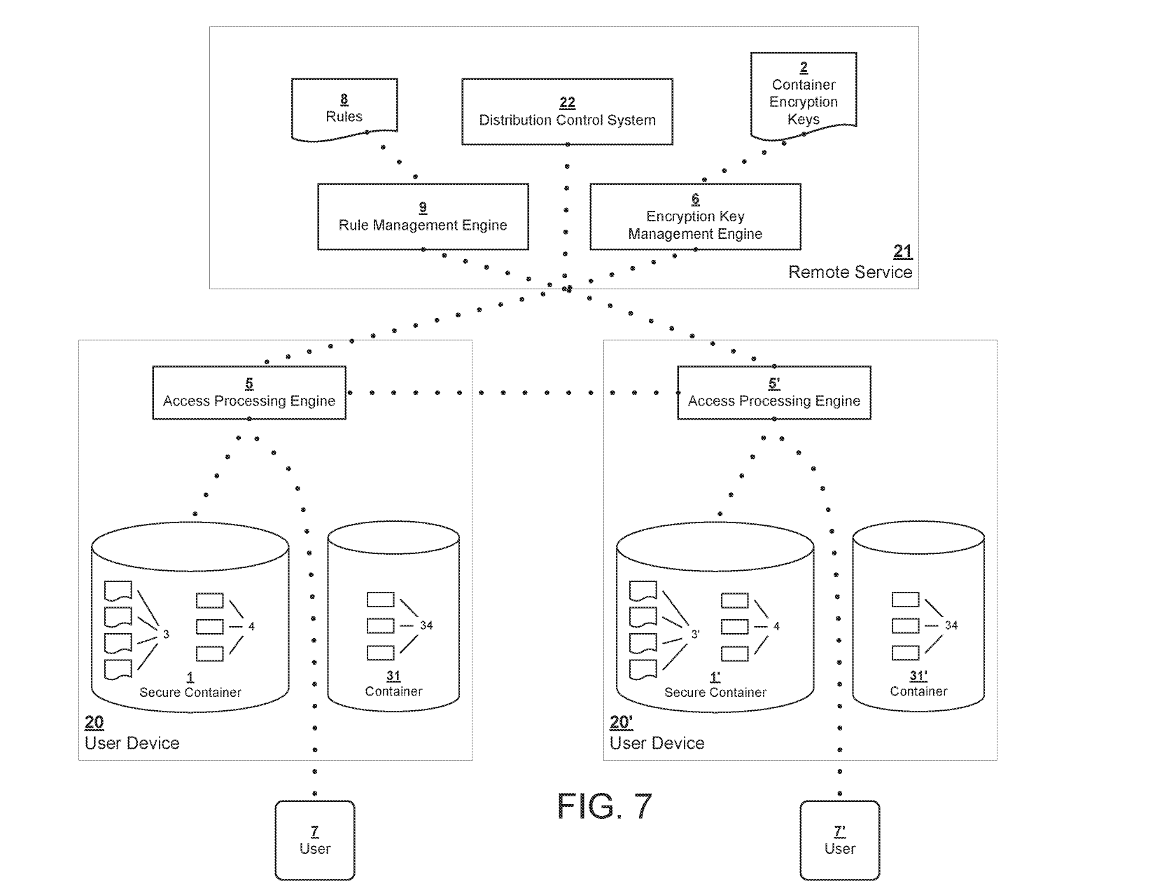

In the above example, if a peer-to-peer distribution system is used to copy the contents of container (1′) to secure container (1), or vice versa, a media or content distributor could have more control over the distribution of his content. As an exemplary use case, a content owner may designate to the distribution management system that the contents in the content owner's container (1′) be distributed to any subscriber by transferring the contents into the subscriber's secure container (1). The content owner can place any content into his container (1′) for distribution to all subscribers. The content owner then can set rules in rules management system (9) to govern the access to his protected content. In this example, the rules management system resides with a third party. As a result system (10) becomes a platform for any of the users to be distributors of content without the need to publish the content to a common server. As the next FIG. 7 illustrates any subscriber to system (10) can by a distributor and any subscriber can also be a subscriber.

Conceptually, in the peer-to-peer embodiment it is convenient to introduce the concept of a project. Operationally, a subscriber is invited or requests to join from the distribution system. The access control engine (5) upon being granted access to the project and receiving keys creates secure container (1) using the keys. The responsibility of the distribution system is to ensure the container (1′) is synchronized with all the secure containers belonging to each subscriber such as secure container (1). Each publisher “owns” or controls a project so that only they can read the contents of the synchronized containers. It should also be noted that synchronization does not necessarily mean the contents of container (1′) and the secured containers of the subscribers be exactly mirrored only that the protected content that is to be distributed be distributed to all subscribers.

Because only the publisher has access to the protected content of the project, he can update software simply by updating the software in his container (1′). Similarly, content can be updated or added simply by placing the content container (1′). It should further be noted that when content is distributed, the distribution control system may direct who can talk to who and designate the means for one peer to communicate with another peer, but the actually distribution of content is made directly from one peer to another so that remote system (21) never receives any of the content.

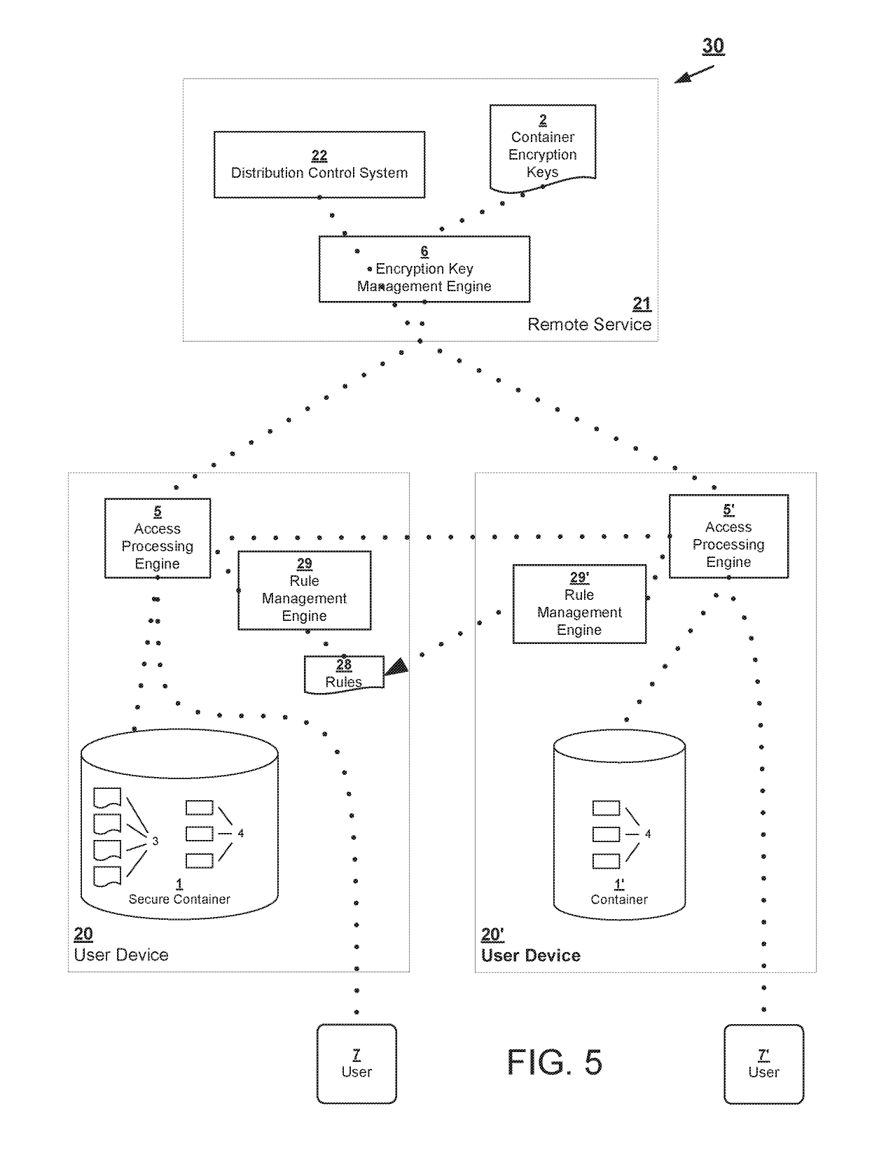

FIG. 5 depicts another embodiment of a piracy prevention, usage control, and distribution system. In this embodiment as in the variation above, the access processing engine (5) meters the usage; however, a local version of the rules management engine (29) resides on the user device (20). Similarly, the second user device (20′) also comprises a local version of the rules management engine (29′). The remote service may also retain a rules management engine, but does not necessarily need to be one. The second user (7′) being the owner of some of the content in the secure container (1) can dictate and change the rules for that content. Unlike in the previous examples, the changes to rules is conveyed directly between user devices without the need to issue rules to a centralized rules management engine (such as remote management system 9 in FIG. 4) in the remote service (21).

Operationally, once the protected content is distributed in a fashion similar to that described for FIG. 4. The user obtains rules (28) from the publisher's rules management system (29′). The user can obtain this on the launch of access processing engine (5) or when the user desires to launch the software or view the protected content. The rules stay resident on user's (7) machine until the access processing engine stops running.

However, in a peer to peer environment this could prove problematic as the publisher may be offline when the request for the rules is made. In a variation to this embodiment, rules (28) can be stored locally on the subscriber user's system by making the rules part of the protected content inside the secured container. The rules can initially be retrieved from the publisher's rules management system (29′) when the protected content is distributed or at any time subsequent to that. In this way, the rules are distributed along with the protected content and does not require the publisher be online whenever the protected content is to be viewed.

The rules can be in the form of one or more of the licensing terms described through out this specification, such as limiting the usage to a proscribed amount of time. In addition to rules becoming part of the protected content the access processing engine (5) and/or the local rules management (29) can add log information such as usage as part of the protected content. The log information can be transferred back to the publisher's container (1′) where the publisher can review the usage or other log information.

In this configuration, the owner of the content need not trust the remote third party to protect the access conditions to his content. Instead the owner's publishes the rules along with any software and media. If the transfer of content is peer-to-peer, there is no intervening third party to potentially compromise the rules. Once again the roles of publisher and subscriber can be switched or both user can function in both capacities.

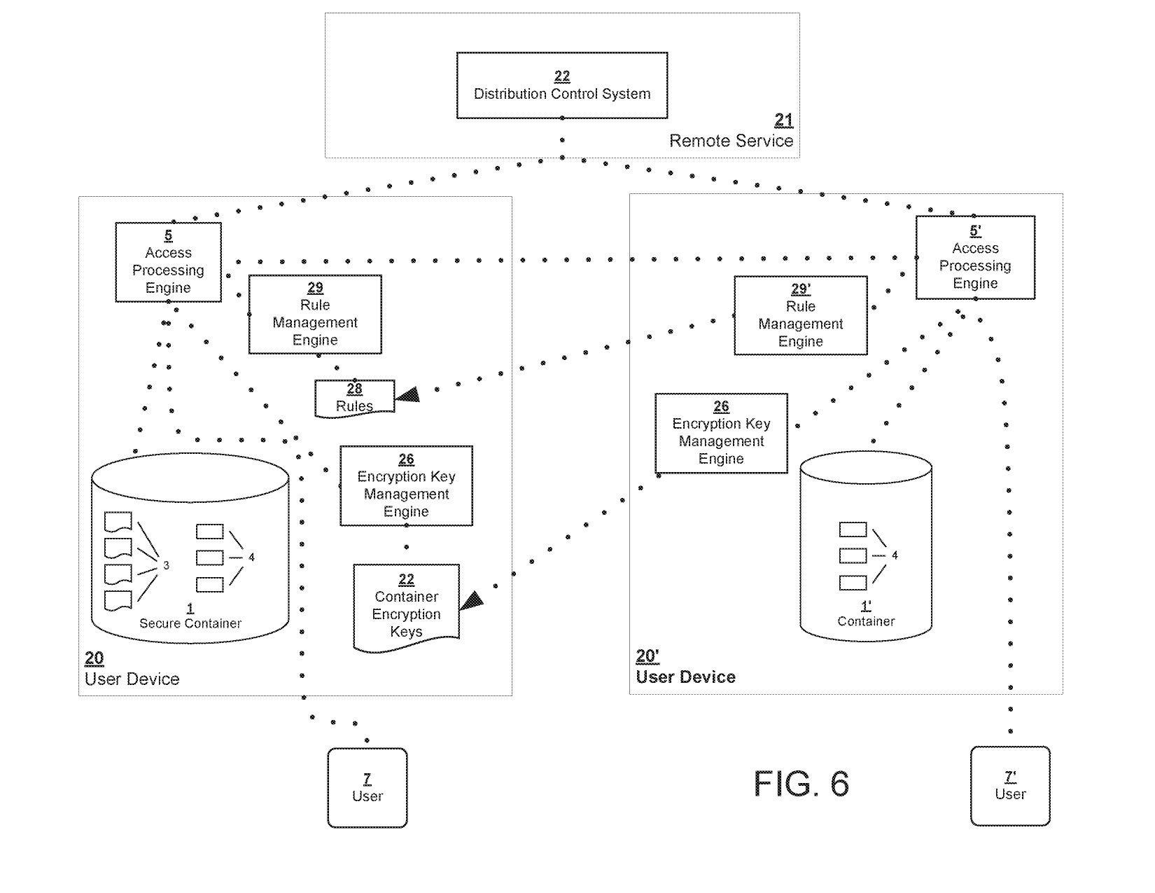

FIG. 6 depicts another embodiment of a piracy prevention, usage control, and distribution system. Further decentralization of control takes place. In this embodiment, the cryptographic keys (22) to the secure container (1) or alternately cryptographic keys (22) necessary to decrypt some of or all of protected data (3,4) in the secure container (1) is provided by the content owner's user device (20′). The keys are managed by cryptographic key management engine (26′) on the content owner's user device (20′). On the content user's user device (20), the cryptographic key management engine (26) receives the cryptographic key from the cryptographic key management engine (26′). In this fashion, the content would not be compromised even if the remote service (21) has been compromised.

By way of a specific example, it is useful to consider the system of FIG. 6 in context of the project paradigm described in conjunction with FIG. 4. In one mode of operation, the subscriber user (7) requests to join a project either unsolicited or by invitation. The distribution control system forwards the request to the publisher's device (20′). Upon acceptance by the publisher, the publishers encryption management system (26′) generates cryptographic container keys (22) and transmits them to the subscriber's encryption management system (26) where secure container (1) is created using those keys. After the distribution management system can facilitate the synchronization of data between peers. In this fashion the security of the protected content lies only in the publisher's hands and never with remote system (21). In this way as well, publisher user (7′) is in control of the membership to the project so that only member of his choosing can participate. Furthermore, user (7′) can also revoke access to the control.

In order to maintain security, the keys are not permanently stored on system (20′) so that when access is revoked, or simply user (7) is finished viewing the content or running protected software the secure container is closed. Generally speaking, since the keys are only needed for the creation of the secure container or the initial opening of the secure container. The keys can be removed from system (20′) upon creation or opening of the secure container.

After the initial setup as described is performed, at a later time, in order to view the protected content or run the protected software, the subscriber user's encryption management system (26′) requests the encryption container keys (22) from the publisher user's encryption management system (26). Using those keys, secure container (1) can be opened for use by access processing engine (5) and operation can proceed in a similar manner to the previous embodiments described.

This mode of operation does suffer the difficulty that the subscriber can not access the content if the publisher is offline. This situation can be remedied if during the initial setup of the subscriber's secure container, the subscriber sends a public key to the publisher. The publisher then encrypts the container keys with the subscriber's public key and stores the encrypted container encryption keys with remote system (21). Because the subscriber is employ a public key encryption system, only the subscriber can decipher the encrypted container encryption keys.

When the subscriber wishes to view the protected content or run the protected software, he can first attempt to obtain the container encryption keys from the publisher device (20′). If the publisher is no longer online, he can retrieve the encrypted container encryption keys from the remote system (21). Unlike the container encryption keys received from the publisher device, the encrypted container encryption keys must be encrypted to prevent any form of man in the middle attack in the event remote system (21) is compromised. If the encrypted container encryption keys are obtained from remote system (21), the subscriber's encryption management system (26) can decipher the container encryption keys using a private key corresponding to the public key sent to the publisher during the initial setup.

If a set of keys is mirrored on remote system (21), the publisher would need to manage those keys as well. For instance if a subscriber's access is to be revoked, the publisher would have to remove the encrypted container encryption key from remote system (21) as well as remove his local copy of the container encryption key from his encryption management system (26′). But in this fashion, the publisher has full control over the protected content even if remote system (21) is compromised.

Alternatively, instead of the publisher storing an encrypted container encryption key at remote system (21). During the initial process of setting up the secured container, the subscriber can encrypt the container encryption key with a private key using private key encryption. The subscriber would then store at the remote system the encrypted container encryption key. In effect, the remote system is holding the encrypted container encryption key “in escrow” when the subscriber is not using it.

FIG. 7 depicts another embodiment of a piracy prevention, usage control, and distribution system. In this example, both a first user (7) and second user (7′) are content owners and content users. The user device (20) of the first user (7) comprises a second container (31) and user device (20′) of the second user (7′) comprises a second container (31′) which is secured along with cryptographic keys (33) to control access to secure container (31′). As a content owner, a user (7) can distribute content by placing protected program instructions (34) is placed into container (31). It then can be transmitted to user device (7′) and placed into secure container (31′). As a content user, user (7) can execute protected program instructions (4) that was received from user (7′). Likewise, user (7′) can function as both a content owner and a content user. In one distribution model, secure container (1′) mirrors container (31) and secure container (1) mirrors container (31′).

As can be seen in this example, the role of user (7) and user (7′) are symmetric. User (7) could be the publisher of content and user (7′) the subscriber, or vice versa, or both at the same time. In order for user (7) to publish content or software, he merely adds the content into container (31) and registers licensing terms with rules management system (9). User (7′) then receives the content into secured container (31′), but can not read the protected content. The access processing system (5′) in accordance to rules placed by user (7) into the rules management system (9) can launch the protected software or launch a media player capable of the playing the protected media content or launch a content viewer capable of viewing the protected content. During no part of the process, does user (7′) have any form of read access to the protected content. While FIG. 7 illustrates the symmetric nature of the publisher and subscriber users in the configuration of FIG. 4. One of ordinary skill in the art can appreciate that this symmetry can extend to the embodiments depicted in FIG. 5 and FIG. 6.

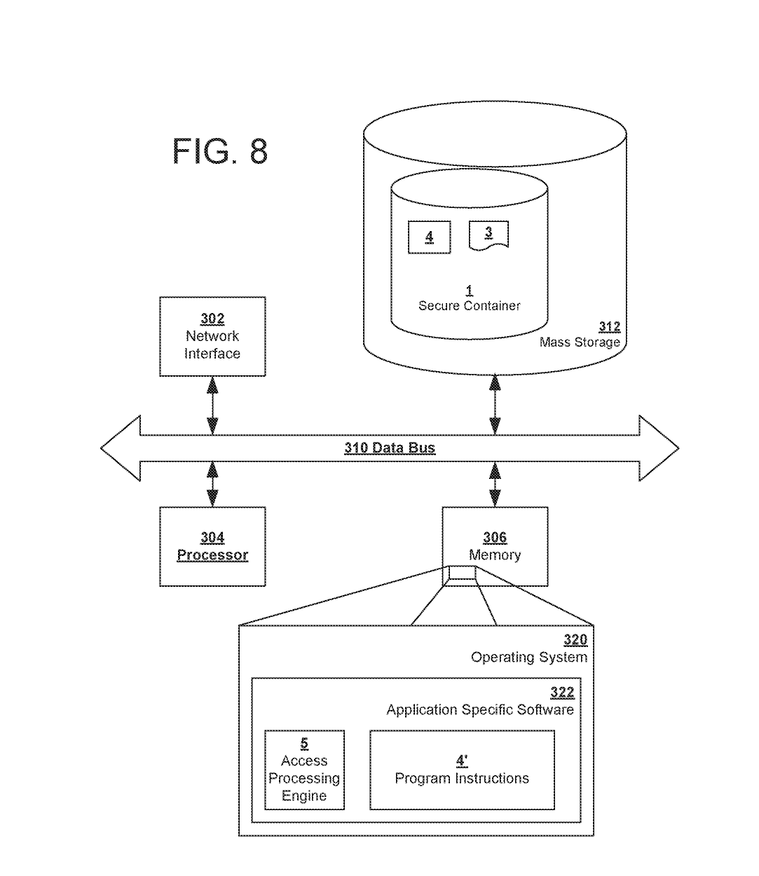

FIG. 8 shows an embodiment of a user device (20) equipped with piracy prevention, usage control and a distribution system. Generally, user device (20) comprises network interface (302), processor (304), memory (306) and optionally mass storage (312) which all communicate using one or more data buses (310), which can include internal data buses, external serial buses, universal serial bus (USB), Peripheral Component Interconnect (PCI) bus, Serial Advanced Technology Attachment (SATA), external SATA (eSATA), etc.

Network interface (302) is used to couple user device (20) to remote services (21) or to other user devices (e.g., user device (20′)). Network interface (302) can be embodied as a network interface card (NIC), network adapter, etc. Network interface (302) can be configured to carry data using the internet protocol (IP) with transmission control protocol (TCP) or user datagram protocol (UDP) and can be based on any number of data link protocols including but not limited to Ethernet, Point-to-Point Protocol (PPP), High-Level Data Link Control (HDLC) and Advanced Data Communication Control Protocol (ADCCP).

Mass storage (312) can comprise any number of storage media including but not limited to a hard disk drive, solid state drive, flash memory, and or optical storage media. Mass storage (312) can be used to house secure container (1). In addition, mass storage (312) is used to supplement memory (306) and is often configured with files in a file system, but may also provide storage for virtual memory as an extension of memory (306). In one embodiment, mass storage (312) can also include cryptographic hardware so that the cryptographic of secure container (1) is implemented in part or entirely in hardware.

Processor (304) can be any device for executing instructions, particularly instructions stored in memory (306). Processor (306) can comprise any commercially available processor such as a central processor unit (CPU), floating-point processor unit (FPU), graphics processing unit (GPU), a multicore processor, a microprocessor (either in the form of a microchip or chip set), a macroprocessor, or generally any device for executing software instructions. In addition, processor (306) can comprise a custom made processing device such as one made from a programmable logic array (PLA), field programmable gate array (FPGA), application specific integrated circuit (ASIC), solution on a chip (SOC), or combinations thereof.

Memory (306) can comprise any one or combination of volatile memory elements such as random access memory (RAM) (for example, dynamic RAM (DRAM), static RAM (SRAM), synchronous dynamic RAM (SDRAM), double data rate (DDR) RAM, etc. and/or nonvolatile memory elements such as read only memory (ROM), flash memory, hard drive, tape, optical media, etc.). In addition, memory (306) can comprise various components such as program memory for storing processor instructions, data memory for storing data used by the processor (304), and/or various levels of caches. It should be noted that mass storage (312) and memory (306) can share much of the same functionality, for example, program instructions can be stored both in mass storage (312) and read into memory (306) as the processor executes the program instructions. Therefore, one of ordinary skill in the art should note that though described separately in this embodiment, memory (306) can perform any function described for mass storage (312).

Furthermore, protected program instructions (4) as well as associated content can be loaded from the secure container (1) which resides on mass storage (312) into memory (306) where processor (304) can execute protected program instructions (4′) while resident in memory (306).

The software in memory (306) can include one or more separate programs, each of which includes an ordered listing of executable instructions for implementing logical functions. Typically, the software in memory (306) may initially be stored in mass storage (312), read into memory (306) for execution by processor (304) and can include operating system (320). Executing within the operating system is application specific software (322). It should be noted, however, that the modules within application specific software (322) can be implemented in software, hardware or a combination of software and hardware. In addition to controlling and executing application specific software (322), operating system (320) can be configured to manage hardware resources including but not limited to input-output control, file and data management, memory management, communications controls and provide software services including but not limited to controlling the execution of other computer programs, scheduling, and inter-process communications.

Application specific software (322) includes the access processing engine (5). Specifically, access processing engine (5) can facilitate retrieval of cryptographic keys (2) from remote services (21) through network interface (302), mirroring of secure container (1) with other containers on other user devices (e.g., container (1′) on user device (7′) also through network interface (302) and access control of secure container (1). Access processing engine (5) in order to control access of secure container (1) can create the secure container on encrypted mass storage or implement it as an encrypted virtual file system such as one using file system in userspace (FUSE).

As used herein, “cryptographic key,” “cryptographic keys,” or “one or more cryptographic keys” can refer to any type of symmetric (“private key”) or asymmetric (“public key”) cryptographic system, the identification and implementation of which are apparent to one of ordinary skill in the art. In an embodiment of the invention, a symmetric cryptographic system is employed wherein the same cryptographic key is used to both encrypt and decrypt the program instructions and/or content.

The advantages of the present invention include, without limitation, the ability to control and limit usage of software and other arbitrary processing engines within a secure container, the ability to control and limit the access to data and organization of said data within a secure container, and to enact this control based on the data being accessed, the reason for access, the user requesting the access, and so forth.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A peer-to-peer network communication method implemented between a first user device and a second user device, the method comprising the steps of:
storing program instructions and content in a first container at a first user device;
mirroring the program instructions and content of the first container to a second secure container at a second user device; and
creating, at the first user device, rules governing access to the program instructions and content in the second secure container via an access processing engine residing on the second user device, wherein only the access processing engine residing on the second user device can grant access to the program instructions and content.

2. The method of claim 1, wherein mirroring the program instructions and content of the first container to the second secure container comprises the step of encrypting the program instructions and content via one or more cryptographic keys.

3. The method of claim 2, further comprising the steps of:
executing the access processing engine at the second user device; and
processing, via the access processing engine, the rules governing access to the program instructions and content, and if the rules permit access, then:
decrypting, at the second user device, the program instructions and content in the second secure container via the one or more cryptographic keys;
executing, at the second user device, a process according to the decrypted program instructions; and
reading, via the process executed at the second user device, the decrypted content;
and if the rules do not permit access, then:
preventing decryption, at the second user device, of the program instructions and content, execution of a process according to the program instructions, and reading of the content by the process according to the program instructions.

4. The method of claim 3, further comprising the steps of:
updating, at the first user device, the rules governing access to the program instructions and content; and
processing, via the access processing engine, the updated rules governing access to the program instructions and content, and if the updated rules permit access, then:
decrypting, at the second user device, the program instructions and content in the second secure container via the one or more cryptographic keys;
executing, at the second user device, a process according to the decrypted program instructions; and
reading, via the process executed at the second user device, the decrypted content;
and if the updated rules do not permit access, then:
preventing decryption, at the second user device, of the program instructions and content, execution of a process according to the program instructions, and reading of the content by the process according to the program instructions.

5. The method of claim 3, further comprising the step of storing the rules in the first container.

6. The method of claim 3, further comprising the step of transferring the rules from the first user device to a remote service.

7. The method of claim 3, wherein the one or more cryptographic keys are never stored at the second user device.

8. The method of claim 7, wherein the one or more cryptographic keys are received from a key management engine, wherein the key management engine is remote from the user device.

9. The method of claim 1, wherein the process is a viewer and the content comprises a document or source code.

10. The method of claim 3, wherein the process is a media player and the content comprises protected media.

11. A user device comprising:
a secure container comprising program instructions and content;
an access processing engine, wherein only the access processing engine can grant access to the program instructions and content within the secure container; and
rules governing access to the program instructions and content in the secure container via the access processing engine, wherein the rules are created by another user device.

12. The user device of claim 11, wherein the secure container is encrypted via one or more cryptographic keys.

13. The user device of claim 12, wherein the access processing engine is configured to:
process the rules governing access to the program instructions and content, and if the rules permit access, then the user device can:
decrypt the program instructions and content in the secure container via the one or more cryptographic keys;
execute a process according to the decrypted program instructions; and
read, via the process, the decrypted content;
and if the rules do not permit access, then the user device is prevented from decrypting the program instructions and content, executing a process according to the program instructions, and reading of the content by the process according to the program instructions.

14. The user device of claim 13, further comprising updated rules governing access to the program instructions, which replace the rules governing access to the program instructions, and wherein the access processing engine is configured to:
process the updated rules governing access to the program instructions and content, and if the updated rules permit access, then the user device can:
decrypt the program instructions and content in the secure container via the one or more cryptographic keys;
execute a process according to the decrypted program instructions; and
read, via the process, the decrypted content;
and if the updated rules do not permit access, then the user device is prevented from decrypting the program instructions and content, executing a process according to the program instructions, and reading of the content by the process according to the program instructions.

15. The user device of claim 13, wherein the rules are stored in the secure container.

16. The user device of claim 13, wherein the one or more cryptographic keys are never stored at the user device.

17. The user device of claim 17, wherein the one or more cryptographic keys are received from a key management engine, wherein the key management engine is remote from the user device.

18. The user device of claim 11, wherein the process is a viewer and the content comprises a document or source code.

19. A secure communication method implemented on a user device, the method comprising the steps of:
receiving, at a first user device, program instructions and content from a second user device;
storing, at the first user device, the program instructions and content in a secure container, wherein storing the program instructions and content in the secure container comprises the step of encrypting the program instructions and content via one or more cryptographic keys; and
receiving, at the first user device, rules governing access to the program instructions and content in the secure container via an access processing engine residing on the first user device, wherein only the access processing engine can grant access to the program instructions and content.

20. The method of claim 19, further comprising the steps of:
executing the access processing engine at the first user device; and
processing, via the access processing engine, the rules governing access to the program instructions and content, and if the rules permit access, then:
decrypting, at the first user device, the program instructions and content in the secure container via the one or more cryptographic keys;
executing, at the first user device, a process according to the decrypted program instructions; and
reading, via the process executed at the first user device, the decrypted content;
and if the rules do not permit access, then:
preventing decryption, at the first user device, of the program instructions and content, execution of a process according to the program instructions, and reading of the content by the process according to the program instructions.
